(19) United States
(12) Patent Application Publication
(10) Pub. No.: US 2009/0291303 A1
(43) Pub. Date: Nov. 26, 2009

(54) ADHESIVE TAPE WITH TEXTILE CARRIER FOR CABLE BANDAGING

(75) Inventors: Patrik Kopf, Hamburg (DE); Andreas Wahlers-Schmidlin, Guderhandviertel (DE)

Correspondence Address: NORRIS, MCLAUGHLIN & MARCUS, P.A., 875 THIRD AVE, 18TH FLOOR, NEW YORK, NY, 10022, US

(73) Assignee: TESA SE, Hamburg (DE)

(21) Appl. No.: 12/470,243

(22) Filed: May 21, 2009

(30) Foreign Application Priority Data
May 23, 2008 (DE) 102008024814.2
Jun. 17, 2008 (DE) 102008028427.0

(51) Int. Cl. B32B 27/02; B32B 37/12

(52) U.S. Cl. 428/365; 442/149; 442/151; 156/185

(57) ABSTRACT

Adhesive tape for jacketing elongate material having a nonwoven-based carrier provided at least on one side with an adhesive coating, the carrier having a basis weight of 30 to 120 g/m², and the carrier being composed of at least one ply of a preconsolidated nonwoven webfiber that is overstitched with a multiplicity of threads, and has a thread density of less than 22 threads per 25 mm width of the carrier.

The invention relates to an adhesive tape intended preferably for wrapping elongate material, such as lines or cable looms more particularly, having a textile carrier and having a pressure-sensitive adhesive coating applied at least to one side of the carrier. The invention further relates to the use of the adhesive tape and also to an elongate material such as a cable harness which is jacketed with the adhesive tape of the invention.

In numerous sectors of industry, bundles composed of a multiplicity of electrical lines are wrapped either before installation or when already mounted, in order to reduce the space taken up by the bundle of lines, by means of bandaging, and also to obtain protective functions. With film-backed adhesive tapes a certain protection against ingress of liquid is achieved; with adhesive tapes based on thick nonwovens or foams as carriers, damping properties are obtained; and, when stable, abrasion-resistant carrier materials are used, a protective function against scuffing and rubbing is achieved.

The use of adhesive tapes having a nonwoven as carrier for the bandaging of cable harnesses is known. DE 94 01 037 U1 or EP 0 668 336 A1, for instance, describe an adhesive tape having a tapelike textile carrier composed of a stitchbonded nonwoven formed in turn from a multiplicity of sewn-in stitches running parallel to one another. On the basis of its special make-up, the adhesive tape described exhibits noise suppression properties when it is used for cable harness bandaging. For this type of nonwoven, stitchbonding machines of the “Maliwatt” type from Karl Mayer, formerly Malimo, are known and in use. In the process, a base web of cross-laid staple fibers is produced, which without further preconsolidation is passed onto the stitching station, where the threads running parallel to one another are sewn in, and hence the fibers are consolidated. This stitchbonded nonwoven is known to the person skilled in the art as a Maliwatt web. Adhesive tapes composed of Maliwatt and a coating of adhesive have been in use for years, as for example from the company Coroplast GmbH & Co. KG, Wuppertal, under product number 8550, or from the company tesa AG, Hamburg, under product number 51608.

The disadvantage of these carrier materials is that, prior to the overstitching, the fibers acquire no preconsolidation. They are not interlooped with one another. This means that the sheetlike structure formed from the fibers, the base web, has no strength prior to overstitching. Only by overstitching with the parallel threads is the consolidation produced in the textile, in other words the tying-in of the fibers, and the tensile strength, especially in machine direction.

As a consequence of this, a high number of longitudinal threads per unit width (linear density) and a high number of loops per unit length (low stitch length) are necessary in order to achieve sufficient tying-in of the cross-laid fibers. In application examples above, thread counts of 22 to 28 threads/25 mm are usually required; the stitch length is usually 1.0 to 1.3 mm; the thread weight has a standard value of 50 dtex. Lower linear densities and/or higher stitch lengths result in inadequate tying-in of fiber, as a result of which, in the course of unwind, fibers are torn from the reverse of the adhesive tape, and therefore adversely affect the bond strength and mechanical strength of the adhesive tape. This is exacerbated particularly at the cut edges and hence in the case of rolls of adhesive tape having a low width, such as 12 mm or 9 mm. The high number of threads per unit width and/or the low stitch length therefore have economic disadvantages, since a large amount of thread material is used, and the possible manufacturing speed of the carrier as a whole is limited by the stitch length.

A small distance between the parallel threads also has the disadvantage that, particularly at relatively high basis weights, there is an increase in the stiffness in the cross direction, which reduces the conformability of the adhesive tape on winding.

In order to prevent the extraction of fibers from the web, it is not only the case that a high thread density and/or low stitch length are necessary; the nature of the staple fibers used, from which the base web is formed, is also adapted thereto. Relatively long and thick fibers are used (having an average linear fiber density, for example, of about 3.3 dtex, and an average length, for example, of 80 mm), and can then be more effectively fixed by the threads than can thinner and/or shorter fibers. Long and thick fibers, however, have the disadvantage that the base webs produced from them will be at least about 50 to 55 g/m². This then corresponds to a Maliwatt web basis weight of around 65 to 70 g/m². For even lower basis weights, sufficiently uniformity of the fiber distribution over the area is not possible, and so holes and fiber-free points are produced, which makes it impossible for the carrier to be used for adhesive tapes. Consequently, more lightweight and inexpensive carriers for adhesive tapes are not obtainable by this technology.

In addition to the stitchbonded web referred to in the stated publications, there are other carriers which are used in adhesive tapes for cable harness bandaging.

DE 44 42 093 C1 is based on the use of a nonwoven web as a carrier for an adhesive tape, the web being formed by the formation of loops from the fibers of the web to produce a reinforced cross-laid fiber web, viz. a web known to a person skilled in the art under the name Malifleece.

The above-described disadvantages of the Maliwatt web are also manifested in the case of the Malifleece. Inadequate tying-in of fiber results in a high level of fiber extraction or else must be compensated by further measures if the web is used for adhesive tapes. A further factor is that, owing to the absence of a stitching thread, the machine-direction strength is not high, and in particular there is a high level of extension of the adhesive tape, which leads to narrowing and deforming when the adhesive tape is unwound and applied.

DE 100 39 982 A1 describes an adhesive tape based on a web carrier which, with low basis weights of 20 to 80 g/m², produces attenuation values of 3 to 10 dB(A). The preferred web carrier in this case is a staple fiber web without further stitching threads, a spunbonded web (filament web) without stitching threads, or a meltblown web without stitching threads.

The disadvantages of the webs without stitching threads are the absence of the properties that are favourable for their application as carriers for adhesive tapes but that are produced by the stitching threads. These properties include in particular, aside from the tying-in of fiber, the mechanical properties in machine direction. For adhesive tapes, particularly when employed to jacket elongate material, such as cable looms in particular, there is a need for high tensile strength and low extension in machine direction. This can be produced particularly well by a thread which is intermeshed in the web. DE 100 39 982 A1 does refer to a stitchbonded web. That web, however, is of the Maliwatt type, and has the above-described disadvantages of the Maliwatt webs.

Abovementioned webs without stitching threads have inadequate consolidation for use as a carrier of an adhesive tape. Webs of this kind have high levels of extension, and the adhesive tape stretches and narrows on unwind. Moreover, fibers are pulled from the reverse of the web and hence destroy the tack of the adhesive side. Moreover, these adhesive tapes are often impossible to tear by hand, or the torn edge produced is not straight. This therefore greatly restricts the processability of the adhesive tape in cable bandaging.

Abovementioned webs without stitching threads may be treated—subsequently or as part of the web manufacturing process—by mechanical or thermal means or with chemical binders. In that case it is possible to achieve high mechanical strength in the machine direction, and low extension of the web and hence of the adhesive tape manufactured from it, and good tying-in of fiber.

This is described in the following patents.

DE 195 23 494 C1 discloses the use of an adhesive tape having a carrier of a spunbonded polypropylene web. The continuous fibers of the spunbonded web are consolidated thermally by means of a heated embossing calender. As a result, the fibers at the surface undergo incipient melting, bond to one another and are thereby consolidated.

DE 298 04 431 U1 likewise discloses the use of an adhesive tape having a carrier made from a thermally consolidated spunbonded web, the proposed spunbonded web being of polyester.

DE 199 23 399 A1 discloses staple fiber webs, as carriers for adhesive tapes, wherein a small amount of fusible fibers are added as a secondary fiber. After the actual production of the web, these fibers may be activated by heat from hot air or by hot calenders, and they melt and so join the primary fibers to one another.

DE 199 37 446 A1 discloses staple fiber webs, as carriers for adhesive tapes, that are consolidated by addition of chemical binders.

The disadvantage of these webs treated in this way is that they become very stiff and lose their textile character. In the case of the adhesive tape, this means that the tape lacks sufficient flexibility and conformability. After winding onto the cable loom, the stiffness of the end of the adhesive tape means that it does not hold onto the bandage, and there is recoil behaviour (flagging)—that is, the ends of the adhesive tape stand up. Treatment of the webs by measures identified above generally takes place not only in the machine direction but also more or less uniformly in all directions. As a result of this, the adhesive tape produced from them can no longer be torn off crosswise, or can be torn off only with difficulty. In addition there is generally a reduction in the noise-suppressing capacity of the webs.

This means that in practice it is not possible to cater for the contradictory requirements made on the carrier of an adhesive tape for cable bandaging with these webs without stitching threads.

The testing and classification of adhesive tapes for cable jacketing are accomplished in the automotive industry by extensive bodies of standards, such as, for example, LV 312-1 “Protection systems for cable harnesses in motor vehicles, adhesive tapes; test guideline” (02/2008), as a joint standard of the companies Daimler, Audi, BMW and Volkswagen. The suppression of noise by an adhesive tape is determined on the basis of a defined test system and test method. The adhesive tapes are then classified as shown below in Table 1:

TABLE 1
Sound damping classification to LV 312-1 (February 2008)

| Sound damping class | Requirement |
|---|---|
| A no sound damping | 0 to ≦2 dB(A) |
| B low sound damping | >2 to ≦5 dB(A) |
| C moderate sound damping | >5 to ≦10 dB(A) |
| D high sound damping | >10 to ≦15 dB(A) |
| E very high sound damping | >15 dB(A) |

The abrasion resistance of an adhesive tape is determined in accordance with LV312-1 likewise on the basis of a defined test method. The classification of the adhesive tapes with regard to their abrasion resistance, for a mandrel diameter of 5 mm, is given in Table 2:

TABLE 2
Abrasion resistance classification to LV 312-1 (February 2008)

| Abrasion class | Requirement | |
|---|---|---|
| A no abrasion protection | <100 | strokes |
| B low abrasion protection | 100-499 | strokes |
| C moderate abrasion | 500-999 | strokes |
| protection | | |
| D high abrasion protection | 1000-4999 | strokes |
| E very high abrasion | 5000-14999 | strokes |
| protection | | |
| F extremely high abrasion | ≧15000 | strokes |
| protection | | |

It is an object of the invention to obtain a marked improvement over the prior art and to provide an adhesive tape which combines a low specific weight with sufficient noise suppression, sufficient abrasion protection and optimum processability in the jacketing of cables.

### BRIEF DESCRIPTION OF THE DRAWINGS

The invention will now be described in greater detail with reference to the drawings, wherein FIG. 1 is a side view of an adhesive tape in an embodiment of the present invention.

This object is achieved by means of an adhesive tape as described hereinbelow. Further embraced by the concept of the invention are the use of the adhesive tape of the invention, and also a cable harness jacketed with the adhesive tape.

The invention accordingly provides an adhesive tape for jacketing elongate material, such as cable looms more particularly, having a nonwoven-based carrier which is provided at least on one side with an adhesive coating, the carrier having a basis weight of 30 to 120 g/m².

The carrier is composed of at least one ply of a preconsolidated nonwoven web, more particularly a spunbonded web, a melt blown web or a mechanically consolidated (as a result of air jets and/or water jets or by needling) staple fiber web, which is overstitched with a multiplicity of threads which, according to one preferred embodiment, extend parallel to one another in machine direction.

The thread density is less than 22 threads per 25 mm width of the carrier, preferably between 9 and 20 threads per 25 mm.

The base web is produced and consolidated in a first step and then overstitched with the threads extending preferably parallel to one another in a second step.

Surprisingly, and unexpectedly for the person skilled in the art, the very combination of the preconsolidated webs with the overstitching with threads extending parallel to one another produces a suitable carrier for producing a cable wrapping tape. As a result of the separate preconsolidation and the subsequent overstitching of the base webs, it is possible to attain the necessary properties, such as high tensile strength with low extension, good cross-tape tearability with a straight torn edge, low stiffness and good conformability, effective tying-in of fibers, and effective noise suppression.

FIG. 1 shows, diagrammatically, a side view of an adhesive tape of this kind. In the FIGURE, (1) is the preconsolidated web (base web) and (2) is the thread used to overstitch the base web, here shown for example in pillar stitch construction (which is shown in works including the standard work “Vliesstoffe” by W. Albrecht, H. Fuchs, W. Kittelmann, WILEY-VCH Verlag GmbH, 2000, in section 6.2.1.1). As a result of the loops that are formed in the course of overstitching, the web gains a loop side (3) and a reverse side (4). The adhesive layer (5) may be applied on the loop side (3), as shown here, or alternatively on the reverse side (4).

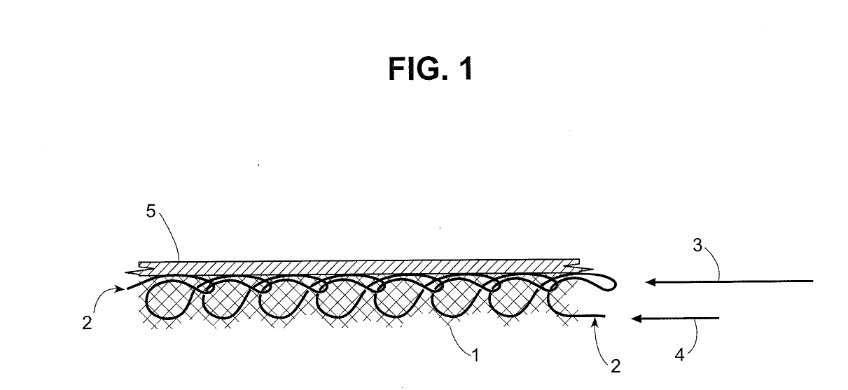

As a result of the preconsolidation of the base web, the thread count of the overstitch threads per 25 mm may be reduced below the FIGURE of 22 threads/25 mm width of the carrier without fibers being torn from the reverse when the adhesive tape is unwound. Preferably the thread count is between 9 and 20 threads/25 mm width of the carrier. A further particularly advantageous value for the thread count is 12 threads/25 mm width of the carrier or 18 threads/25 mm width of the carrier.

Likewise as a result of the preconsolidation of the base web it is possible for the stitch length of the overstitch thread to be above the value of 1.5 mm, preferably 1.5 to 5 mm, more preferably 1.5 to 2.5 mm.

The inventively low thread count per unit width, and the inventively high stitch length, are beneficial to the flexibility of the web carrier and hence to the flexibility of the adhesive tape. Hence, an adhesive tape is obtained which, on account of its flexibility in machine and cross directions, and its conformability, is ideally suited to cable wrapping.

Given a suitable nature of the base web, it is possible to attain noise suppression classes in accordance with automotive standard LV 312-1 of A to D. Given a suitable nature of the base web and of the stitching threads, it is possible to attain abrasion classes in accordance with automotive standard LV 312-1 of A to C.

This astonishing improvement in properties of the base webs as a result of the overstitching and/or of the preconsolidation makes it possible to produce an innovative cable wrapping tape which, given appropriate character, through low thickness when wrapping elongate material, offers a space-saving advantage and provides a saving in weight. In addition, through the use of relatively low basis weights and/or the use of inexpensive web-laying and web preconsolidation methods, it is possible to obtain inexpensive webs as adhesive tape carriers, without foregoing the positive properties of the known, Maliwatt-type stitchbonded webs in the context of processing of the adhesive tape and protection of the wrapped cable loom.

As the base web it is possible to use all known nonwoven webs, the “nonwoven web” comprehending at least sheetlike structures in accordance with DIN EN 29092 (August 1992).

Suitable nonwovens are staple fiber webs, but also filament webs (spunbonded webs) and meltblown webs. Known consolidation methods for the webs are mechanical, thermal and chemical consolidation.

A preconsolidated web in accordance with the invention is a web whose ultimate tensile strength in machine direction, measured in accordance with DIN EN 29073-3 (August 1992), is above 2 N/cm or 10 N/50 mm.

Particular advantage is possessed by a staple fiber web which in the first step is preconsolidated by needling or which is preconsolidated by jets of air or water. A web of this kind is characterized in that, as a result of the formation of loops from fibers of the web or by needling, a significant fraction of the staple fibers is oriented at least partly vertically. This has the advantage that, as a result, the abrasion resistance of the web and its suppression of noise are improved. Consequently, for a given basis weight, it is possible to achieve better abrasion resistance and noise suppression on the part of the subsequent adhesive tape than in the case of webs which have not undergone preconsolidation. As a result of the overstitching with threads that extend parallel to one another, this improvement in properties then becomes utilizable for adhesive tapes as well.

Additionally particularly advantageous is the use of a filament web (spunbonded web) as the base web. In this case, from a polymer melt, through a spinneret die and by means of a stream of hot air, continuous filaments are produced and are laid down on a conveyor belt. As a result of the entangling of the continuous filaments, a web is formed in the course of the laydown operation. For consolidation, the web is immediately thereafter consolidated thermally by means of a heated calender. In the case of use of an embossing roll, thermal embossing is produced. In this case only a low level of thermal treatment is needed in order to ensure the preconsolidation. As a result it is possible to keep the stiffness of the web low. This is because the later overstitching generates the necessary longitudinal strength and contributes to the tying-in of fiber.

The consolidation after laydown of the continuous filaments may take place alternatively or additionally to the thermal treatment by means of air jets or water jets as well. In the case of consolidation exclusively by means of water jets it is possible very much more effectively to produce a textile character in the nonwoven than by calendering, since through the water jets it is possible to bring about, rather than significant incipient melting of the fibers, their intermeshing with one another, and also, in particular, an at least partly vertical orientation of the filament fibers. The textile produced is termed a water-jet-consolidated spunbonded web.

Additionally particularly advantageous is the use of a meltblown web as the base web. In this case, fibers are “sprayed” onto a screen from a polymer solution, with assistance by (hot) streams of air. As a result it is possible to produce very fine fibers which, given appropriate polymer selection and operating regime, can give the resulting webs a textile character.

The threads are subsequently introduced into the web in a stitching/stitchbonding operation by the formation of thread loops, the web being overstitched as a result. This can be carried out, for example, using the warp-knit machines or stitchbonding machines of the companies Karl Mayer Textilmaschinen GmbH, Obertshausen, or LIBA Maschinenfabrik GmbH, Naila. Rows of threads are formed, which may be introduced in pillar stitch construction or tricot construction. It is preferred to employ the pillar stitch construction. The distance of the parallel rows of threads from one another is given, for example, as the number of threads per 25 mm web width, for example 14/25 mm, and then referred to as fineness (linear density) F14. In addition a particular distance between the points of stitch entry is set, known as the stitch length, of 2.0 mm, for example.

Furthermore, it is also possible for two or more plies of similar or different webs to be joined to one another in one operation in the course of overstitching. As a result, advantages and properties of the different webs can be combined.

Furthermore, subsequent calendering of the web carrier may produce compaction of the web, which may be beneficial for the uniformity of the web and the required application of adhesive. By calendering is meant the compressing of the web between two rolls under pressure and possibly at elevated temperature.

The web is preferably composed of polyester, polypropylene, polyethylene or polyamide fibers (staple fibers or continuous filament fibers). Cellulosic fibers as well, especially viscose fibers, may be present at least proportionally.

With further preference the (stitching) thread is composed of polyester, polypropylene, polyethylene or polyamide.

In order to produce an adhesive tape from the carrier, it is possible to employ all known adhesive systems. Besides natural or synthetic rubber-based adhesives it is possible more particularly to use silicone adhesives and also polyacrylate adhesives. Preferably the adhesive is a pressure-sensitive adhesive, in other words a viscoelastic mass which in the dry state at room temperature remains permanently tacky and adhesive. Bonding is accomplished under gentle applied pressure instantaneously to virtually all substrates.

The application weight ranges, in accordance with one preferred embodiment, in the range between 20 to 100 g/m².

Preferred on account of their particular suitability as adhesives for wrapping tapes for automotive cable looms, in respect of the absence of fogging and also the outstanding compatibility with both PVC and PVC-free core insulations, are solvent-free acrylate hotmelt compositions, as described in more detail in DE 198 07 752 A1 and also in DE 100 11 788 A1.

One adhesive which is found to be particularly suitable is a low molecular mass, pressure-sensitive, acrylate hotmelt adhesive of the kind carried under the name acResin UV by BASF. This adhesive, with a low K value, acquires its application-compatible properties as a result of a concluding, radiation-induced crosslinking operation.

With great preference the adhesive coating is composed of a synthetic rubber-based adhesive, more particularly an adhesive comprising at least one vinylaromatic block copolymer and an at least partly hydrogenated tackifier resin.

The vinylaromatic block copolymer can be a styrene block copolymer, more particularly a hydrogenated block copolymer.

(Pressure-sensitive) adhesives employed include those based on block copolymers containing polymer blocks formed from vinylaromatics (A blocks) such as styrene, for example, and blocks formed by polymerization of 1,3-dienes (B blocks) such as, for example, butadiene and isoprene or a copolymer of the two. It is also possible to use mixtures of different block copolymers. Preference is given to using products which are partly or fully hydrogenated.

The block copolymers may have a linear A-B-A structure. Likewise possible for use are block copolymers of radial architecture, and also star-shaped and linear multiblock copolymers. As a further component it is possible to use A-B diblock copolymers.

Instead of the polystyrene blocks it is also possible to utilize polymer blocks based on other aromatics-containing homopolymers and copolymers (preferably C₈ to C₁₂ aromatics) with glass transition temperatures of >75° C., such as aromatics blocks containing α-methylstyrene for example. Likewise possible for utilization are polymer blocks based on (meth)acrylate homopolymers and (meth)acrylate copolymers with glass transition temperatures of >75° C. In this context it is possible to employ not only block copolymers which utilize as hard blocks exclusively those based on (meth)acrylate polymers but also block copolymers which utilize both polyaromatics blocks, polystyrene blocks for example, and poly(meth)acrylate blocks.

Instead of styrene-butadiene block copolymers and styrene-isoprene block copolymers and/or their hydrogenation products, viz. styrene-ethylene/butylene block copolymers and styrene-ethylene/propylene block copolymers, it is likewise possible in accordance with the invention to utilize block copolymers and their hydrogenation products which utilize further polydiene-containing elastomer blocks, such as copolymers of two or more different 1,3-dienes, for example. Possible for utilization in accordance with the invention, furthermore, are functionalized block copolymers such as maleic anhydride-modified or silane-modified styrene block copolymers, for example.

Typical use concentrations for the block copolymer are situated at a concentration in the range between 30% and 70% by weight, more particularly in the range between 35% and 55% by weight.

As further polymers it is possible for those based on pure hydrocarbons, such as unsaturated polydienes, for example, such as natural or synthetically produced polyisoprene or polybutadiene, chemically substantially saturated elastomers, such as saturated ethylene-propylene copolymers, α-olefin copolymers, polyisobutylene, butyl rubber, ethylene-propylene rubber, for example, and also chemically functionalized hydrocarbons such as halogen-, acrylate- or vinyl ether-containing polyolefins, for example, to be present, and these polymers may replace up to half of the vinylaromatics-containing block copolymers.

Preferably the hydrogenated tackifier resin is a hydrogenated hydrocarbon resin.

Tackifiers used are tackifier resins which are compatible with the elastomer block of the styrene block copolymers and are at least partly hydrogenated. Suitable tackifier resins include preferably partially or fully hydrogenated resins based on rosin or on rosin derivatives. It is also possible to obtain at least partly hydrogenated hydrocarbon resins, hydrogenated hydrocarbon resins for example, by partial or complete hydrogenation of aromatics-containing hydrocarbon resins (for example Arkon P and Arkon M Series from Arakawa or Regalite Series from Eastman), hydrocarbon resins based on hydrogenated dicyclopentadiene polymers (for example Escorez 5300 Series from Exxon), hydrocarbon resins based on hydrogenated C₅/C₉ resins (Escorez 5600 Series from Exxon) or hydrocarbon resins based on hydrogenated C₅ resins (Eastotac from Eastman) and/or mixtures thereof. Hydrogenated polyterpene resins based on polyterpenes can be used as well. Aforementioned tackifier resins can be used either alone or in a mixture.

As further additives it is possible typically to use light stabilizers, such as, for example, UV absorbers, sterically hindered amines, antiozonants, metal deactivators, processing auxiliaries, and endblock-reinforcing resins.

Plasticizing agents such as, for example, liquid resins, plasticizer oils or liquid polymers of low molecular mass, such as low-molecular-mass polyisobutylenes with molar masses <1500 g/mol (number average) or liquid EPDM types, for example, are typically employed.

Fillers such as, for example, silicon dioxide, glass (ground or in the form of beads), aluminium oxides, zinc oxides, calcium carbonate, titanium dioxide, carbon blacks, to name but a few, and also colour pigments and dyes, and also optical brighteners, can likewise be used.

Styrene block copolymer-based PSAs are typically admixed with primary and secondary antioxidants in order to enhance their ageing stability. Primary antioxidants react with oxy and peroxy radicals, which can form in the presence of oxygen, and react with them to form less reactive compounds. Secondary antioxidants reduce, for example, hydroperoxides to alcohols. There is known to be a synergistic effect between primary and secondary ageing inhibitors, and so the protective effect of a mixture is frequently greater than the sum of the two individual effects. Primary antioxidants used on a standard basis in styrene block copolymer-based PSAs are very frequently sterically hindered phenols, which carry a 3-(p-hydroxyphenyl)propionic acid moiety or a 3-(o-hydroxyphenyl)propionic acid group, such as for example Irganox 1010, Irganox 1076, Irganox 259, Irganox 1035 and Irganox 1135 from Ciba Additive, Sumilizer BP 101 and Sumilizer BP 76 from Sumitomo or Hostanox O 10 and Hostanox O 16 from Clariant or Lowinox PP 35 and Lowinox PO 35 from Chemische Werke Lowi, to name but a few. Compounds which have shown themselves particularly suitable are mononuclear and/or polynuclear phenols which contain a benzyl thioether moiety positioned ortho and/or para to the phenolic OH group. Of preferential suitability are 4,6-bis(octylthiomethyl)-o-cresol and 4,6-bis(dodecylthiomethyl)-o-cresol, mononuclear phenols of the kind supplied, for example by Ciba under the brand name Irganox 1520 and Irganox 1726, respectively.

These can ideally be used in combination with secondary antioxidants.

If the adhesive tape described is to be of low flammability, this quality can be achieved by adding flame retardants to the carrier and/or to the adhesive. These retardants may be organobromine compounds, where appropriate with synergists such as antimony trioxide, although, with regard to the absence of halogen from the adhesive tape, preference will be given to using red phosphorus, organophosphorus compounds, mineral compounds or intumescent compounds, such as ammonium polyphosphate, alone or in conjunction with synergists.

The pressure-sensitive adhesives may be prepared and processed from solution, from dispersion and also from the melt. Preferred preparation and processing methods are from the melt. For the latter case, suitable preparation processes include both batch methods and continuous methods. The continuous manufacture of the pressure-sensitive adhesive by means of an extruder and subsequent coating directly onto the substrate to be coated at a correspondingly high temperature of the adhesive is particularly preferred.

The adhesives thus prepared can then be applied to the carrier using the methods that are general knowledge. In the case of processing from the melt, these application methods may be via a nozzle or a calender. In the case of methods from solution, coatings with rods, blades or nozzles are known, to name but a few. Also possible is the transfer of the adhesive from a non-stick backing cloth or release liner onto the carrier assembly.

The general expression “adhesive tape” in the context of this invention encompasses all sheetlike structures such as two-dimensionally extended films or film sections, tapes with extended length and limited width, tape sections and the like, and also, lastly, diecuts or labels.

The adhesive tape may be produced alternatively in the form of a roll, in other words wound up onto itself in the form of an Archimedean spiral, or lined on the adhesive side with release materials such as siliconized paper or siliconized film.

Suitable release material is preferably a non-linting material such as a polymeric film or a well-sized, long-fibered paper.

The reverse face of the adhesive tape may be coated with a reverse-face lacquer in order to exert a favourable influence on the unwind properties of the adhesive tape wound to an Archimedean spiral. For this purpose this reverse-face lacquer may be furnished with silicone compounds or fluorosilicone compounds and also with polyvinylstearylcarbamate, polyethyleneiminestearylcarbamide or organofluorine compounds as adhesive substances.

The adhesive tape is preferably used for jacketing elongate material such as, more particularly, cable looms, the elongate material being wrapped in an axial direction by the adhesive tape, or the adhesive tape being passed in a helical spiral around the elongate material.

Finally, the concept of the invention also embraces an elongate material jacketed with an adhesive tape of the invention. The elongate material preferably comprises a cable loom.

On the basis of the outstanding suitability of the adhesive tape, it can be used in a wrapping which is composed of an enclosure, the self-adhesive tape being present at least in one edge region of the enclosure, and being bonded on the enclosure in such a way that the adhesive tape extends over one of the longitudinal edges of the enclosure, preferably in an edge region which is narrow by comparison with the width of the enclosure.

A product of this kind, and also optimized embodiments thereof, are disclosed in EP 1 312 097 A1. EP 1 300 452 A2, DE 102 29 527 A1 and WO 2006 108 871 A1 show further developments which are likewise very suitable for the adhesive tape of the invention. The adhesive tape of the invention can also be used in a method as disclosed by EP 1 367 608 A2. Finally, EP 1 315 781 A1 and also DE 103 29 994 A1 describe embodiments of adhesive tapes of a kind also possible for the adhesive tape of the invention.

Table 3 illustrates the invention by a number of examples, without thereby wishing to restrict the invention.

The measurements took place in accordance with the following standards:
Basis weights of the webs and of the coating to DIN EN ISO 2286-2
Ultimate tensile strength and ultimate tensile strength extension of the webs in the machine direction to DIN EN 29073-3 in a sample width of 50 mm, a clamped-in length of 100 mm and a pulling speed of 300 mm/min
Ultimate tensile strength and ultimate tensile strength extension of the adhesive tapes in machine direction to DIN EN 1940 and DIN EN 1941 at the maximum of the breaking elongation curve (clamped-in length 100 mm, pulling speed 300 mm/min)
Bond strength to DIN EN 1939
Web and adhesive tape thicknesses to DIN EN 1942
(Stitching) thread thickness to DIN EN ISO 2060
Flagging, noise suppression, abrasion resistance and hand tearability to LV312-1.
The flexural stiffness was measured using a softometer KWS basic 2000 mN from Wolf Messtechnik, Freiberg, in accordance with the universal softometer process

All of the values are representative averages.

TABLE 3
Examples and counterexamples of carriers
and adhesive tapes produced therefrom

| | | Example | | | | |
|---|---|---|---|---|---|---|
| Parameter | Unit | A | B | 1 | 2 | 3 |
| Base web | | | | | | |
| Fiber material | | PET | PET | PET | PP | PET |
| Basis weight | g/m² | 60 | 48 | 49 | 45 | 30 |
| Thickness | μm | 220 | 200 | 225 | 240 | 130 |
| Ultimate tensile strength | N/cm | about | 24 | 22 | 28 | 14 |
| | | 0.2 | | | | |
| Ultimate tensile strength | % | | 35 | 61 | 111 | 22 |
| extension | | | | | | |
| Overstitched web | | | | | | |
| Stitching thread material | | PET | none | PET | PET | PET |
| Stitching thread thickness | dtex | 50 | | 50 | 50 | 33 |
| Number of stitching | 1/25 | 22 | | 12 | 12 | 14 |
| threads, linear density | mm | | | | | |
| Stitch length | mm | 1.0 | | 2.0 | 2.0 | 2.5 |
| Basis weight | g/m² | 75 | | 56 | 53 | 35 |
| Ultimate tensile strength | N/cm | 38 | | 26 | 28 | 26 |
| Ultimate tensile strength | % | 18 | | 23 | 19 | 26 |
| extension | | | | | | |
| Flexural stiffness MD | mN | 1-2 | 20-35 | 1-2 | 2-4 | 1-3 |
| Flexural stiffness CD | mN | 2-4 | 15-20 | 1-2 | 1-2 | 1-2 |
| Adhesive tape | | | | | | |
| Total thickness | μm | 280 | 220 | 270 | 280 | 160 |
| Adhesive coatweight | g/m² | 70 | 35 | 50 | 50 | 40 |
| Type of adhesive | | K | Ac | K | Ac | K |
| Ultimate tensile strength | N/cm | 38 | 26 | 32 | 28 | 26 |
| Ultimate tensile strength | % | 18 | 30 | 24 | 19 | 24 |
| extension | | | | | | |
| Bond strength to steel | N/cm | 3.0 | 2.8 | 3.6 | 2.6 | 3.6 |
| Flagging after 24 h | mm | 0 | 15 | 0 | 0 | 0 |
| Tearable by hand | | Yes | Limited | Yes | Yes | Yes |
| Noise suppression | dB (A) | 5.5 | 5.0 | 6.0 | 6.3 | 4.0 |
| Abrasion class, 5 mm rod | | A | A | A | A | A |

Examples A and B are counterexamples (hereinafter “Counterexamples A and B”). Counterexample A is the Maliwatt-type stitchbonded nonwoven of EP 0 668 336 A1. “Base web” here is the unconsolidated fiber array; the overstitched web is then the Maliwatt web known to the person skilled in the art. The adhesive tape is the web coated with adhesive and slit to form tapes.

Counterexample B is a staple fiber web with cross-laid fibers of which 20% by weight are fusible fibers. The web is not overstitched and is therefore a web along the lines of DE 199 23 399 A1.

Example 1 is the base web of a cross-laid staple fiber web that has undergone water jet consolidation.

Example 2 is the base web of a filament web (spunbonded web) whose filaments have been consolidated solely by water jets.

Example 3 is the base web of a filament web (spunbonded web) whose filaments have undergone thermal consolidation via an embossing roll.

The abbreviations are PET for polyester, PP for polypropylene, K for rubber-based, Ac for acrylate-based. For all of the examples, the direction of the stitching threads was the machine direction, and the construction was pillar stitch.

Counterexample A shows an adhesive tape which is in accordance with the requirements for cable wrapping: high tensile strength, low extension, little fiber extraction from the reverse of the web (represented by a high bond strength to steel), no flagging, hand-tearable, and sufficient noise suppression.

Webs such as Counterexample B (without thread overstitching, consolidation solely by water jets and fusible fibers) do achieve sufficiently high tensile strengths and moderate extensions, on account of the fusible fibers, but the strong consolidation results in a high flexural stiffness. This flexural stiffness is a measure of the poor flexibility of the web and its lack of textile character. The result is also a stiff adhesive tape, which is difficult to process when used for cable wrapping, and exhibits high flagging and only limited hand tearability. The requirements imposed on an adhesive tape for cable wrapping are therefore not met.

Example 1 shows an adhesive tape of the invention whose carrier has been produced by overstitching a preconsolidated web. This adhesive tape exhibits the application-compatible features for cable wrapping: despite a smaller number of stitching threads and a higher stitch length, there is little fiber extraction from the reverse of the web (evident from the high bond strength to steel after unwinding of the roll), the mechanical data are in conformity with requirements, there is no flagging, it is hand-tearable, and noise suppression is sufficient. The flexibility in cross direction, represented by the flexural stiffness CD, is lower than for Counterexample A.

In the case of Examples 2 and 3, the base webs used were spunbonded webs; here again, despite the small number of stitching threads and/or the high stitch length, application-compatible properties are obtained, and the adhesive tape is highly flexible in all directions.

What is claimed is:

1. Adhesive tape for jacketing elongate material, said adhesive tape comprising a nonwoven-based carrier which is provided at least on one side with an adhesive coating, the carrier having a basis weight of 30 to 120 g/m², wherein the carrier is composed of at least one ply of a preconsolidated nonwoven webfiber, which is overstitched with a multiplicity of threads, and has a thread density of less than 22 threads per 25 mm width of the carrier.

2. Adhesive tape according to claim 1, wherein the preconsolidated nonwoven web is composed of polyester, polypropylene, polyethylene or polyamide fibers.

3. Adhesive tape according to claim 1, wherein the multiplicity of threads are composed of polyester, polypropylene, polyethylene or polyamide.

4. Adhesive tape according to claim 1, wherein the multiplicity of threads extend parallel to one another in a machine direction.

5. Adhesive tape according claim 1, wherein the carrier has a stitch length of more than 1.5 mm.

6. Adhesive tape according to claim 1, wherein the preconsolidated web possesses an ultimate tensile strength of at least 2 N/cm.

7. Adhesive tape according to claim 1, wherein the carrier is composed of two or more plies of similar or different webs that are stitched together by the threads extending parallel to one another.

8. Adhesive tape according to claim 1, wherein the web material is compacted as a result of calendering.

9. Adhesive tape according to claim 1, wherein the preconsolidated nonwoven web is a mechanically consolidated staple fiber web consolidated as a result of air jets and/or water jets or by needling.

10. Adhesive tape according to claim 1, wherein the adhesive coating comprises an adhesive based on natural rubber, synthetic rubber, acrylate or silicone.

11. Adhesive tape according to claim 1, wherein the adhesive coating comprises a low molecular mass, pressure-sensitive, acrylate hotmelt adhesive.

12. Adhesive tape according to claim 1, wherein the preconsolidated nonwoven web is a spunbonded web, a meltblown web or a mechanically consolidated staple fiber web.

13. Adhesive tape according to claim 1, wherein the thread density is between 9 and 20 threads per 25 mm width of the carrier

14. Adhesive tape according to claim 2, wherein the polyester, polypropylene, polyethylene or polyamide fibers are staple fibers or continuous fibers

15. Adhesive tape according to claim 5, wherein the stitch length is between 1.5 to 5 mm.

16. Method for jacketing elongate material, the method comprising: passing an adhesive tape according to claim 1 around the elongate material in a helical line.

17. Method according to claim 16, wherein the elongate material is wrapped in an axial direction by the adhesive tape.

18. Method according to claim 16, wherein the elongate material is a cable loom.

19. Elongate material jacketed with an adhesive tape according to claim 1.

20. Elongate material according to claim 19, wherein the elongate material is a cable loom.
